(19) United States
(12) Patent Application Publication
(10) Pub. No.: US 2012/0249446 A1
(43) Pub. Date: Oct. 4, 2012

(54) TOUCH-SENSING APPARATUS

(75) Inventors: Chun-Hung Chen, Taipei City (TW); Chih-Peng Hsia, Hsinchu County (TW); Chih-Yuan Chang, Hsinchu County (TW); He-Wei Huang, Hsinchu City (TW); Chun-Ching Huang, Hsinchu City (TW)

(73) Assignee: NOVATEK MICROELECTRONICS CORP., Hsinchu (TW)

(21) Appl. No.: 13/350,825

(22) Filed: Jan. 16, 2012

(30) Foreign Application Priority Data
Apr. 1, 2011 (TW) 100111558

(51) Int. Cl. G06F 3/041

(52) U.S. Cl. 345/173

(57) ABSTRACT

A touch-sensing apparatus including a touch panel and a touch-sensing controller is provided. The touch panel includes a plurality of touch blocks. Each of the touch blocks includes a first portion and a second portion. The touch-sensing controller includes a driving line and a plurality of sensing lines. The driving line is coupled to the first portions of the touch blocks, and the sensing lines are respectively coupled to the second portions of the touch blocks. The touch-sensing controller outputs a driving signal to the first portions through the driving line and receives a plurality of sensing signals generated by the second portions according to the driving signal through the sensing lines, so as to determine a touch coordinates corresponding to one of the touch blocks.

### CROSS-REFERENCE TO RELATED APPLICATION

This application claims the priority benefit of Taiwan application serial no. 100111558, filed on Apr. 1, 2011. The entirety of the above-mentioned patent application is hereby incorporated by reference herein and made a part of this specification.

### BACKGROUND OF THE INVENTION

1. Field of the Invention

The invention generally relates to a sensing apparatus, and more particularly, to a touch-sensing apparatus.

2. Description of Related Art

In today's information age, people rely more and more on electronic products. Different types of electronic products, such as notebook computers, mobile phones, personal digital assistants (PDAs), and walkmans, have become indispensable tools in our daily life. Each of aforementioned electronic products has an input interface which allows a user to input a command, such that the internal system of the electronic product can automatically execute the command.

In order to provide a more friendly operation mode, a touch pad or touch panel is usually disposed on an electronic product as an input interface so that a user can input commands through the touch pad or touch panel. A touch pad with button-type input not only allows a user to input commands intuitionally but also offers a true touch experience during actual operation thanks to the multi-touch function offered by the button-type design. Capacitive touch apparatuses are one of the most common touch apparatuses in the market, and can be categorized into self-sensing touch apparatuses and mutual-sensing touch apparatuses according to the touch-sensing techniques thereof. A button-type input interface is usually disposed with a self-sensing touch apparatus so that when a finger touches a button and accordingly the capacitance of the button changes, the touch-sensing circuit can detect the corresponding touch position according to the capacitance variation. Because any liquid on a self-sensing touch apparatus can produce the same capacitance variation as that produced by a finger touch, the touch-sensing circuit may detect the touch position incorrectly. Accordingly, a conventional self-sensing touch apparatus is not water-proof.

On the other hand, in a mutual-sensing touch apparatus, the capacitance variation produced by liquid is reverse to that produced by a finger touch. Thus, mutual-sensing touch apparatuses offer a water-proof effect. Additionally, in a mutual-sensing touch apparatus, a fine X-Y coordinate system is realized by disposing two layers of sensing strings that are arranged along different directions on the input interface. Thus, a mutual-sensing touch apparatus needs to be operated in a double-ended manner. Thereby, a button-type input interface with single-ended touch-sensing function cannot be adopted along with a mutual-sensing touch apparatus.

### SUMMARY OF THE INVENTION

Accordingly, the invention is directed to a touch-sensing apparatus which offers a true touch effect and avoids any liquid-caused misoperation.

The invention provides a touch-sensing apparatus including a touch panel and a touch-sensing controller. The touch panel includes a plurality of touch blocks, wherein each of the touch blocks includes a first portion and a second portion. The touch-sensing controller includes a first driving line and a plurality of first sensing lines. The first driving line is coupled to the first portions of the touch blocks, and the first sensing lines are respectively coupled to the second portions of the touch blocks. The touch-sensing controller outputs a first driving signal to the first portions through the first driving line and receives a plurality of first sensing signals generated by the second portions according to the first driving signal through the first sensing lines, so as to determine a touch coordinates corresponding to one of the touch blocks.

According to an embodiment of the invention, the touch-sensing controller includes a driving module and a sensing module. The driving module outputs the first driving signal to the first portions through the first driving line according to a control signal. The sensing module receives the first sensing signals through the first sensing lines and generates a touch information according to the first sensing signals.

According to an embodiment of the invention, the touch-sensing controller further includes a processing module. The processing module is coupled to the driving module and the sensing module, and the processing module outputs the control signal to the driving module and determines the touch coordinates corresponding to one of the touch blocks according to the touch information.

According to an embodiment of the invention, the touch panel further includes a plurality of second driving lines and a plurality of second sensing lines. The second driving lines and the second sensing lines are coupled to the touch-sensing controller. The touch-sensing controller outputs a plurality of second driving signals to the touch panel through the second driving lines and receives a plurality of second sensing signals corresponding to the second driving signals through the second sensing lines.

According to an embodiment of the invention, the first driving signal is coupled to the second portions of the touch blocks through the first portions of the touch blocks to generate the first sensing signals.

According to an embodiment of the invention, the first portion and the second portion of each of the touch blocks respectively include a first annulus and a second annulus, and the first annulus and the second annulus are concentric and coplanar.

According to an embodiment of the invention, the first portion and the second portion of each of the touch blocks are distributed in a spiral manner and are extended toward the inside of the touch block.

According to an embodiment of the invention, the first portion and the second portion of each of the touch blocks are in an annular polygonal shape and have a same geometric center.

According to an embodiment of the invention, the first portion and the second portion of each of the touch blocks respectively include a sawtooth portion, and the sawtooth portions are arranged in an alternating manner

According to an embodiment of the invention, the first portion and the second portion of each of the touch blocks respectively present a comb shape and are arranged in an alternating manner.

According to an embodiment of the invention, the first portion and the second portion of each of the touch blocks form a petal shape.

According to an embodiment of the invention, the first portions are connected with each other to produce a diamond pattern.

According to an embodiment of the invention, the first portion of each of the touch blocks has a disposition area, and the second portion of the touch block is located within the disposition area.

According to an embodiment of the invention, the second portion of each of the touch blocks has a disposition area, and the first portion of the touch block is located within the disposition area.

As described above, in an embodiment of the invention, the touch-sensing controller determines a touch coordinates corresponding to each touch block by providing a first driving signal to the first portions of the touch blocks and receiving a plurality of first sensing signals generated by the second portions of the touch blocks according to the first driving signal. Thereby, a true touch effect can be achieved and any misoperation caused by liquid can be avoided.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a touch-sensing apparatus according to an embodiment of the invention.

FIG. 2A is a diagram illustrating the situation when a finger touches a touch block.

FIG. 2B is a diagram illustrating the situation when a liquid touches a touch block.

FIG. 3 is a diagram of touch blocks according to another embodiment of the invention.

FIG. 4 is a diagram of touch blocks according to another embodiment of the invention.

FIG. 5 is a diagram of touch blocks according to another embodiment of the invention.

FIG. 6A and FIG. 6B are diagrams of touch blocks according to another embodiment of the invention.

FIG. 7A and FIG. 7B are diagrams of touch blocks according to another embodiment of the invention.

FIGS. 8A-8C are diagrams of touch blocks according to another embodiment of the invention.

FIG. 9 is a diagram of touch blocks according to another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Following embodiments will be described by taking a capacitive touch panel as an example. However, those having ordinary knowledge in the art should understand that the application of the invention is not limited to the capacitive touch panel.

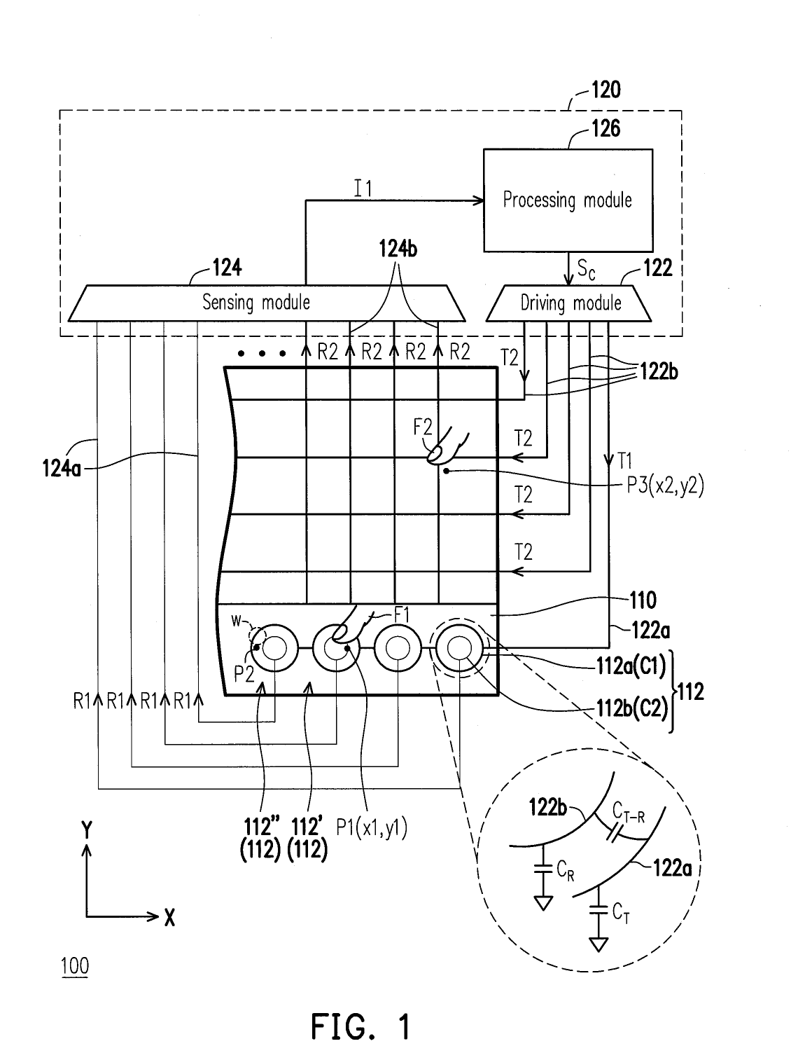

FIG. 1 is a diagram of a touch-sensing apparatus according to an embodiment of the invention. In the present embodiment, the touch-sensing apparatus 100 includes a touch panel 110 and a touch-sensing controller 120. The touch panel 110 includes a plurality of touch blocks 112, and each of the touch blocks 112 includes a first portion 112a and a second portion 112b. The touch-sensing controller 120 includes a driving line 122a and a plurality of sensing lines 124a. The driving line 122a is coupled to the first portion 112a of each touch block 112, and the sensing lines 124a are respectively coupled to the second portions 112b of the touch blocks 112. The touch-sensing controller 120 outputs a driving signal T1 to the first portions 112a through the driving line 122a and receives a plurality of sensing signals R1 generated according to the driving signal T1 through the sensing lines 124a. Accordingly, the touch-sensing controller 120 can determine a touch coordinates corresponding to one of the touch blocks 112 (for example, the coordinates (x1, y1) corresponding to a touch block 112′) according to the sensing signals R1. In the present embodiment, the driving signal T1 may be coupled to the second portions 112b through the first portions 112a to generate the corresponding sensing signals R1. Additionally, in the present embodiment, the touch blocks 112 and the touch coordinates have a one-on-one relationship. For example, the four touch blocks 112 in FIG. 1 are corresponding to four different touch coordinates. In other words, the touch operations are corresponding to the same touch coordinates (x1, y1) as long as the first portion 112a or second portion 112b touched by a finger F1 belongs to the same touch block 112′, which is different from the technique in which the touch coordinates of a touch position is determined through interpolation.

In the present embodiment, the touch-sensing controller 120 includes a driving module 122 and a sensing module 124. The driving module 122 outputs the driving signal T1 according to a control signal S_{C} and transmits the driving signal T1 to the first portions 112a of the touch blocks 112 through the driving line 122a. The sensing module 124 receives the sensing signals R1 through the sensing lines 124a and generates a touch information I1 according to the sensing signals R1, wherein the sensing signals R1 are generated according to the driving signal T1. In addition, the touch-sensing controller 120 in the present embodiment further includes a processing module 126 coupled to the driving module 122 and the sensing module 124. As shown in FIG. 1, the processing module 126 outputs the control signal S_{C} to the driving module 122 and determines a touch coordinates (for example, the touch coordinates (x1, y1)) on the touch panel 110 according to the touch information I1.

To be specific, in the present embodiment, the touch blocks 112 adopt a button-type design and accordingly, the sensing module 124 can detect the touch state of each touch block 112 to achieve a true touch effect. The touch blocks 112 may be function keys on an electronic device (for example, a cell phone). As shown in FIG. 1, the first portion 112a of each touch block 112 includes an annulus C1, and the second portion 112b of each touch block 112 includes an annulus C2, wherein the annulus C1 and the annulus C2 are concentric and coplanar. Unlike that in a conventional button-type touch apparatus, in the present embodiment, the touch blocks 112 receive the driving signal T1 through one ends (i.e., the first portions 112a or the annuluses C1) and transmit the sensing signals R1 through the other ends (i.e., the second portions 112b or the annuluses C2) to achieve a mutual-sensing effect. To be specific, because the first portions 112a and the second portions 112b of the touch blocks 112 are not electrically connected with each other and the first portions 112a receive the driving signal T1 through the driving line 122a while the second portions 112b output the sensing signals R1 through the sensing lines 124a, the touch-sensing controller 120 can repeatedly detect the capacitors C_{T} of the first portions 112a, the capacitors C_{R} of the second portions 112b, and the coupling capacitors C_{T-R} in a mutual-sensing manner. On the other hand, in the present embodiment, because the four touch blocks 112 receive the driving signal T1 through the same driving line 122a, the circuit layout space is reduced.

Specifically, as shown in FIG. 1, the first portions 112a and the second portions 112b of the touch blocks 112 can be respectively considered as grounded models of the capacitors C_{T} and C_{R}, and the capacitors C_{T} and C_{R} can produce the coupling capacitors C_{T-R}, wherein the touch-sensing controller 120 can measure the equivalent capacitance of the touch block 112′ at a sensing end (i.e., the second portion 112b) through voltage division and accordingly determine the touch coordinates (x1, y1) of the position P1. For example, when the touch block 112 or 112′ is not touched, the equivalent capacitance measured from the sensing end may be the capacitance obtained by connecting the capacitors C_{T-R} and C_{T} with each other in series and then with the capacitor C_{R} in parallel. Below, the capacitance variation of the touch block 112′ when the touch block 112′ is touched will be further explained.

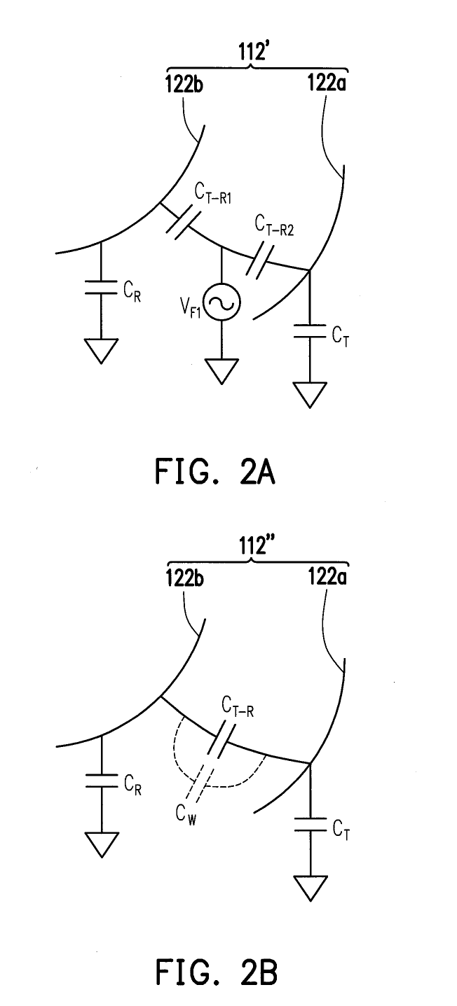

FIG. 2A is a diagram illustrating the situation when a finger touches a touch block 112′. Referring to both FIG. 1 and FIG. 2A, when the finger F1 (as shown in FIG. 1) touches the position P1 within the touch block 112′, because the finger F1 changes the electric field of the touch block 112′, the original coupling capacitor C_{T-R} turns into a model of two capacitors C_{T-R1} and C_{T-R2} connected to a micro voltage V_{F1} (for example, of several millivolts). Thus, when the finger F1 touches the position P1, the touch-sensing controller 120 detects that the capacitance of the touch block 112′ changes at the sensing end and accordingly determines the touch coordinates (x1, y1). For example, when the touch block 112′ is touched by the finger F1, the equivalent capacitance measured from the sensing end is the capacitance obtained by connecting the three capacitors C_{T-R1}, C_{T-R2} and C_{T} with each other in series and then with the capacitor C_{R} in parallel. Then, when the touch-sensing controller 120 measures the equivalent capacitance of the touch block 112′ at the sensing end through voltage division, the touch-sensing controller 120 may detect that the capacitance of the touch block 112′ decreases. Accordingly, the touch-sensing controller 120 determines that the finger F1 touches the touch block 112′ and the touch coordinates (x1, y1) corresponding to the touch block 112′.

FIG. 2B is a diagram illustrating the situation when a liquid touches the touch block 112″. Referring to both FIG. 1 and FIG. 2B, when a liquid W (for example, a water drop) touches the position P2 within the touch block 112″, a capacitor C_{W} is formed by the liquid W besides the coupling capacitor C_{T-R} and accordingly the capacitance of the touch block 112″ is changed. For example, in the present embodiment, because the capacitor C_{W} and the coupling capacitor C_{T-R} are connected in parallel, the equivalent capacitance measured by the sensing module 124 from the sensing end is higher than that in FIG. 1. It should be noted that in the present embodiment, because the physical characteristic reflected when the liquid W touches the touch block 112″ is reverse to that reflected when the finger F1 touches the touch block 112′, the touch-sensing controller 120 can correctly determine the touch position of the finger F1 without being interfered by the liquid W. In other words, compared to a conventional self-sensing touch apparatus, the touch-sensing apparatus 100 in the present embodiment can distinguish liquid touch and finger touch therefore offers a water-proof effect. Besides, because the touch blocks 112 adopt a button-type design, a true touch effect is achieved.

Referring to FIG. 1 again, in the present embodiment, the touch panel 110 further includes a plurality of driving lines 122b and a plurality of sensing lines 124b, wherein the driving lines 122b and the sensing lines 124b are coupled to the touch-sensing controller 120. The driving module 122 of the touch-sensing controller 120 outputs a plurality of driving signals T2 to the touch panel 110 through the driving lines 122b, and the sensing module 124 thereof receives a plurality of sensing signals R2 corresponding to the driving signals T2 through the sensing lines 124b. To be specific, when a finger F2 touches a position P3 on the touch panel 110, the sensing module 124 detects a variation in the sensing signal R2 corresponding to the position P3 and determines the touch coordinates (x2, y2) of the position P3. Herein the touch coordinates (x2, y2) may be obtained through interpolation, and the variation of the sensing signal R2 may be the variation of the capacitance on the sensing line 124b. Thus, a fine X-Y coordinate system can be realized by disposing the driving lines 122b and the sensing lines 124b on the touch panel 110 as an array and by adopting the interpolation technique. To be specific, assuming that there are 16 driving lines 122b and 16 sensing lines 124b, the touch-sensing controller 120 can determine 256 different touch coordinates through the interpolation technique.

As described above, in the present embodiment, the touch-sensing apparatus 100 performs touch-sensing operations through the touch blocks 112, so as to offer a true touch effect and avoid any liquid-caused misoperation. In addition, a fine X-Y coordinate system is realized through the touch blocks 112 along with the driving lines 122b and the sensing lines 124b that are arranged into an array. Moreover, because the driving lines 122a and 122b are all connected to a driving module 122 and the sensing lines 124a and 124b are all connected to a sensing module 124, the fabrication cost and circuit layout space can be both reduced. In other words, in the present embodiment, the touch blocks 112 with the button-type design can be conveniently integrated with the array-style touch-sensing apparatus. However, it should be noted that in other embodiments, the touch-sensing apparatus 100 may not include the driving lines 122b and the sensing lines 124b but perform the touch-sensing operations completely through the touch blocks 112. Namely, the number or type of sensing units (for example, the touch blocks 112 or the driving lines 122b and the sensing lines 124b) on the touch panel 110 is not limited in the invention and can be determined according to the design requirement.

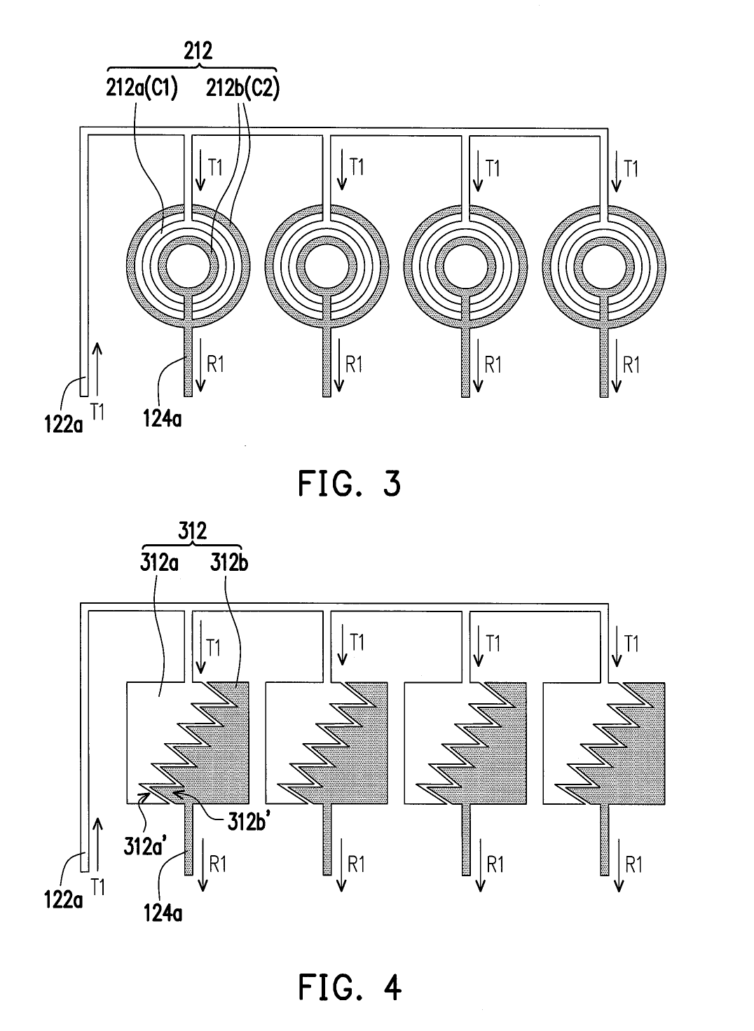

FIG. 3 is a diagram of touch blocks according to another embodiment of the invention. The touch blocks 212 in FIG. 3 are similar to the touch blocks 112 in FIG. 1, and the difference between the two is that the second portion 212b of each touch block 212 includes two annuluses C2, wherein the annulus C1 and the annuluses C2 are arranged in an alternating manner and the annulus C1 is disposed between the two annuluses C2. When the driving signal T1 is transmitted to the annuluses C1, the driving signal T1 is coupled to the annuluses C2 to generate the corresponding sensing signals R1. The sensing signals R1 are then transmitted to the touch-sensing controller 120 through the sensing lines 124a to allow the touch-sensing controller 120 to determine the touch coordinates. It should be noted that even though there are four touch blocks 212 in the present embodiment, the invention is not limited thereto, and in other embodiments, the number of touch blocks 212 may be adjusted by increasing or reducing the numbers of the driving line 122a and the sensing lines 124a. Details of the touch-sensing technique can be understood by referring to foregoing descriptions related to FIGS. 1-2B and therefore will not be described herein.

FIG. 4 is a diagram of touch blocks according to another embodiment of the invention. As shown in FIG. 4, the first portion 312a of each touch block 312 includes a sawtooth portion 312a′, and the second portion 312b thereof includes a sawtooth portion 312b′, wherein the sawtooth portion 312a′ and the sawtooth portion 312b′ are arranged in an alternating manner. When the driving signal T1 is transmitted to the first portion 312a, the driving signal T1 is coupled to the sawtooth portions 312b′ of the second portions 312b through the sawtooth portions 312a′ to generate the corresponding sensing signals R1. The sensing signals R1 are then transmitted to the touch-sensing controller 120 through the sensing lines 124a to allow the touch-sensing controller 120 to determine the touch position. Details of the touch-sensing technique can be understood by referring to foregoing descriptions related to FIGS. 1-2B and therefore will not be described herein.

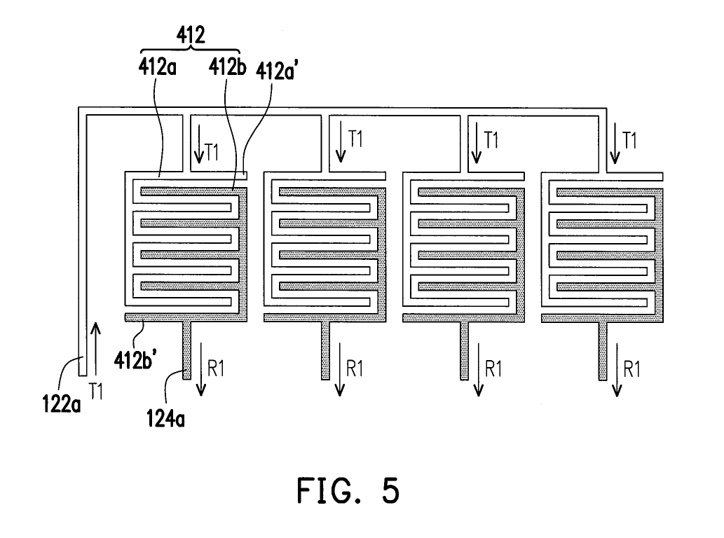

FIG. 5 is a diagram of touch blocks according to yet another embodiment of the invention. Similarly, the first portion 412a and the second portion 412b of each touch block 412 respectively present a comb shape and are arranged in an alternating manner. To be specific, the first portion 412a includes a comb portion 412a′, and the second portion 412b includes a comb portion 412b′, wherein the comb portions 412a′ and 412b′ are arranged in an alternating manner. The driving signal T1 is coupled to the comb portions 412b′ of the second portions 412b through the comb portions 412a′ to generate the corresponding sensing signals R1, and the sensing signals R1 are then transmitted to the touch-sensing controller 120 through the sensing lines 124a to allow the touch-sensing controller 120 to determine the touch position. Details of the touch-sensing technique can be understood by referring to foregoing descriptions related to FIGS. 1-2B and therefore will not be described herein.

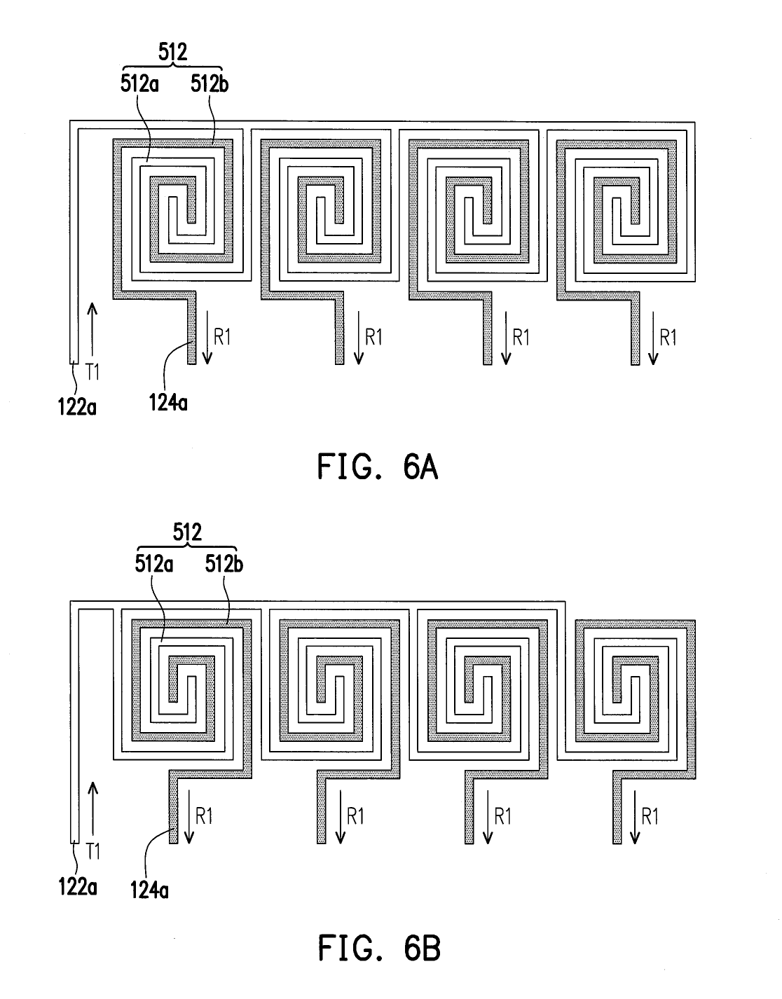

FIG. 6A and FIG. 6B are diagrams of touch blocks according to another embodiment of the invention. As shown in FIG. 6A and FIG. 6B, the first portion 512a and the second portion 512b of each touch block 512 are distributed in a spiral manner and are extended toward the inside of the touch block 512. The same touch-sensing effect can be achieved through such a design. Details of the touch-sensing technique can be understood by referring to foregoing descriptions related to FIGS. 1-2B and therefore will not be described herein.

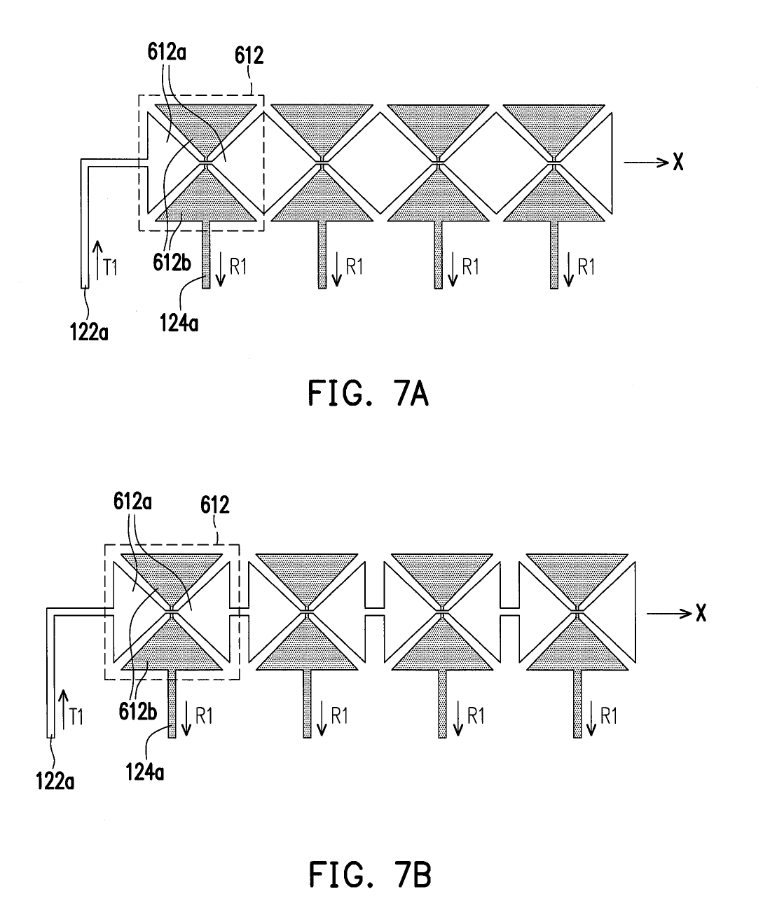

FIG. 7A and FIG. 7B are diagrams of touch blocks according to another embodiment of the invention. As shown in FIG. 7A and FIG. 7B, the first portion 612a and the second portion 612b of each touch block 612 form a petal shape, and all the first portions 612a form a string extended along the direction X. The major difference between FIG. 7A and FIG. 7B is that the first portions 612a of the touch blocks 612 in FIG. 7A are connected with each other to form a diamond pattern. Similar to the embodiments described above, the same touch-sensing effect can be achieved through such a design. Details of the touch-sensing technique can be understood by referring to foregoing descriptions related to FIGS. 1-2B and therefore will not be described herein.

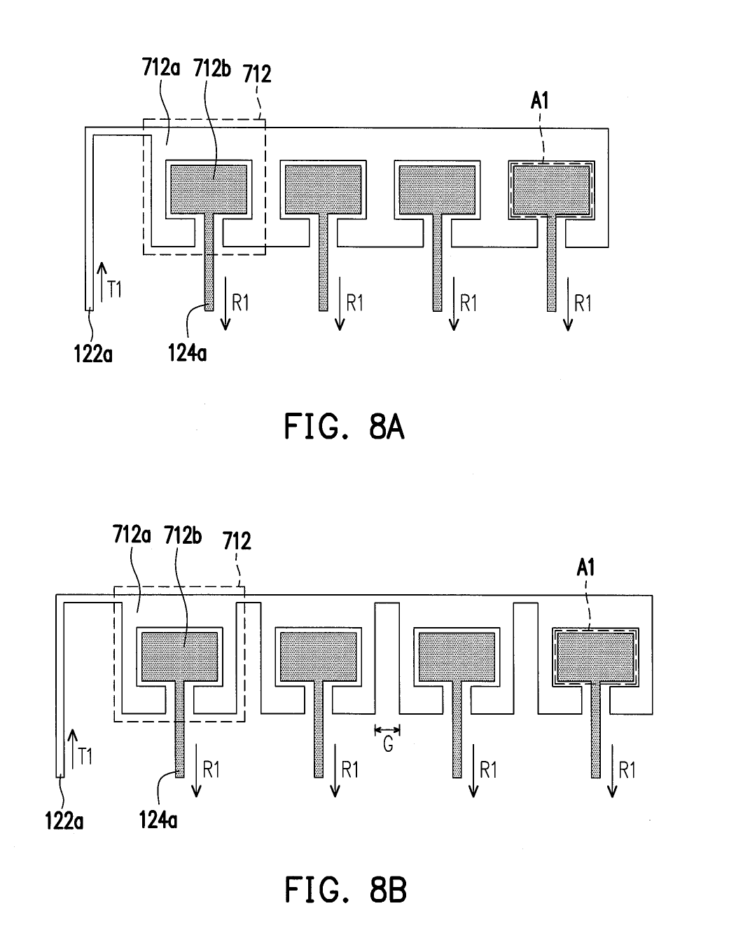

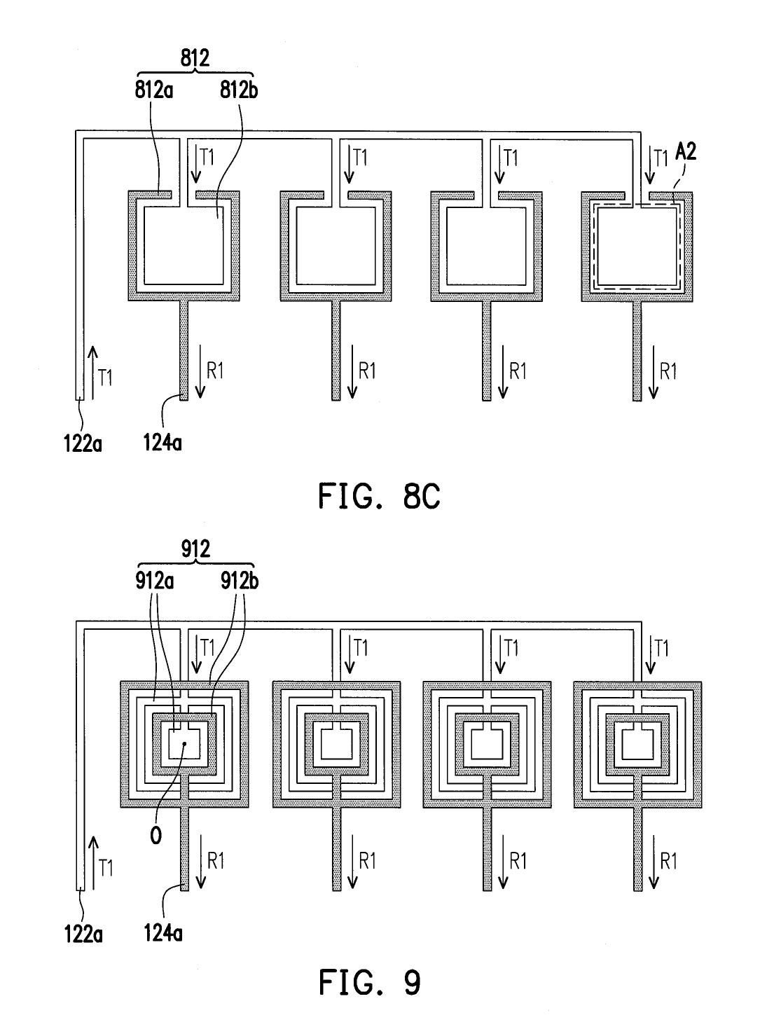

FIGS. 8A-8C are diagrams of touch blocks according to another embodiment of the invention. In FIG. 8A and FIG. 8B, the first portion 712a of each touch block 712 has a disposition area A1, and the second portion 712b of the touch block 712 is located within the disposition area A1. The major difference between FIG. 8A and FIG. 8B is that there is a gap G between the first portions 712a of the touch blocks 712 in FIG. 8B while the first portions 712a of the touch blocks 712 in FIG. 8A are completely connected with each other. Additionally, in FIG. 8C, the second portion 812b of each touch block 812 has a disposition area A2, and the first portion 812a of the touch block 812 is located within the disposition area A2. Similar to the embodiments described above, the same touch-sensing effect can be achieved through such a design. Details of the touch-sensing technique can be understood by referring to foregoing descriptions related to FIGS. 1-2B and therefore will not be described herein.

FIG. 9 is a diagram of touch blocks according to another embodiment of the invention. The touch blocks 912 in FIG. 9 are similar to the touch blocks 212 in FIG. 3, and the difference between the two is that the first portion 912a and the second portion 912b of each touch block 912 are in an annular polygonal shape and have a same geometric center O. In the present embodiment, the annular polygonal shape may be square shape. When the driving signal T1 is transmitted to the first portions 912a, the driving signal T1 is coupled to the second portions 912b to generate the corresponding sensing signals R1. The sensing signals R1 are then transmitted to the touch-sensing controller 120 through the sensing lines 124a to allow the touch-sensing controller 120 to determine the touch position. Details of the touch-sensing technique can be understood by referring to foregoing descriptions related to FIGS. 1-2B and therefore will not be described herein. However, it should be noted that the number and patterns of the touch blocks 212 are only examples but not intended to limit the scope of the invention.

As described above, in an embodiment of the invention, the touch-sensing controller determines a touch coordinates corresponding to each touch block by providing a first driving signal to the first portions of the touch blocks and receiving a plurality of first sensing signals generated by the second portions of the touch blocks according to the first driving signal. Thereby, a true touch effect can be achieved and any misoperation caused by liquid can be avoided.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch-sensing apparatus, comprising:
a touch panel, comprising a plurality of touch blocks, wherein each of the touch blocks comprises a first portion and a second portion; and
a touch-sensing controller, comprising a first driving line and a plurality of first sensing lines, wherein the first driving line is coupled to the first portions of the touch blocks, and the first sensing lines are respectively coupled to the second portions of the touch blocks, wherein the touch-sensing controller outputs a first driving signal to the first portions through the first driving line and receives a plurality of first sensing signals generated by the second portions according to the first driving signal through the first sensing lines, so as to determine a touch coordinates corresponding to one of the touch blocks.

2. The touch-sensing apparatus according to claim 1, wherein the touch-sensing controller comprises:
a driving module, outputting the first driving signal to the first portions through the first driving line according to a control signal; and
a sensing module, receiving the first sensing signals through the first sensing lines and generating a touch information according to the first sensing signals.

3. The touch-sensing apparatus according to claim 2, wherein the touch-sensing controller further comprises a processing module, the processing module is coupled to the driving module and the sensing module, and the processing module outputs the control signal to the driving module and determines the touch coordinates corresponding to one of the touch blocks according to the touch information.

4. The touch-sensing apparatus according to claim 1, wherein the touch panel further comprises a plurality of second driving lines and a plurality of second sensing lines, the second driving lines and the second sensing lines are coupled to the touch-sensing controller, and the touch-sensing controller outputs a plurality of second driving signals to the touch panel through the second driving lines and receives a plurality of second sensing signals corresponding to the second driving signals through the second sensing lines.

5. The touch-sensing apparatus according to claim 1, wherein the first driving signal is coupled to the second portions of the touch blocks through the first portions of the touch blocks to generate the first sensing signals.

6. The touch-sensing apparatus according to claim 1, wherein the first portion and the second portion of each of the touch blocks respectively comprise a first annulus and a second annulus, and the first annulus and the second annulus are concentric and coplanar.

7. The touch-sensing apparatus according to claim 1, wherein the first portion and the second portion of each of the touch blocks are distributed in a spiral manner and are extended toward an inside of the touch block.

8. The touch-sensing apparatus according to claim 1, wherein the first portion and the second portion of each of the touch blocks are in an annular polygonal shape and have a same geometric center.

9. The touch-sensing apparatus according to claim 1, wherein the first portion and the second portion of each of the touch blocks respectively comprise a sawtooth portion, and the sawtooth portions are arranged in an alternating manner.

10. The touch-sensing apparatus according to claim 1, wherein the first portion and the second portion of each of the touch blocks respectively present a comb shape and are arranged in an alternating manner.

11. The touch-sensing apparatus according to claim 1, wherein the first portion and the second portion of each of the touch blocks form a petal shape.

12. The touch-sensing apparatus according to claim 11, wherein the first portions are connected with each other to produce a diamond pattern.

13. The touch-sensing apparatus according to claim 1, wherein the first portion of each of the touch blocks has a disposition area, and the second portion of the touch block is located within the disposition area.

14. The touch-sensing apparatus according to claim 1, wherein the second portion of each of the touch blocks has a disposition area, and the first portion of the touch block is located within the disposition area.
